(19) United States
(12) Patent Application Publication
(10) Pub. No.: US 2004/0156187 A1
(43) Pub. Date: Aug. 12, 2004

(54) Transparent outer tube for a vehicular exhaust pipe

(76) Inventor: Kuo-Tai Chen, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/361,755

(22) Filed: Feb. 11, 2003

(51) Int. Cl. F21V 33/00; B60Q 1/00

(52) U.S. Cl. 362/96; 362/547; 362/544

(57) ABSTRACT

A transparent outer tube for a vehicular exhaust pipe comprises an inner tube, a first outer tube, a second outer tube, a socket and illumination devices. The inner tube is secured within the first outer tube to form a space between the inner tube and the first outer tube. The space receives the socket and the illumination devices therein. The first outer tube is axially secured with the second outer tube. Either the first outer tuber or the second outer tubes, or both of them are made of heat-resistant and transparent material. The second outer tube further comprises a ring. Thus light from the illumination devices emits direct or indirect to the tail of the exhaust pipe or reflects through the first outer tube, the second outer tube or the ring.

### FIELD OF THE INVENTION

This invention relates to a vehicular exhaust pipe having a transparent outer tube, and more particularly, to a first outer tube, a second outer tube or both of them being made of heat-resist and transparent material, the second outer tube further comprising a ring, light reflecting from the first outer tube, the second outer tube, both of the outer tubers or the ring to increase attraction.

### BACKGROUND OF THE INVENTION

There are numerous patented exhaust pipes with illumination devices, such as U.S. Pat. No. 6,491,418, which had cited four previous patented inventions, Pat. Nos. 5,964,312 6,247,830 5,508,478 5,036,947. The U.S. Pat. No. 6,491,418 comprises illumination devices on an exhaust pipe, but doesn't include a transparent outer tube for the illumination to be viewed from side of the tube, but from the tail end. The U.S. Pat. No. 5,036,947 is a lid for an exhaust pipe for a motorcycle without illumination devices and a transparent tube. The U.S. Pat. No. 5,508,478 uses holes on an outer tube which is visible to the flame from the exhaust pipe, but it does not include illumination devices. The U.S. Pat. No. 6,247,830 is related to a lamp lid for agricultural purpose. The U.S. Pat. No. 5,964,312 comprises illumination bolts for a shock absorber.

### SUMMARY OF THE INVENTION

It is the primary object of the present invention to provide a transparent outer tube for a vehicular exhaust pipe, which is more attractive to consumers.

It is another object of the present invention to provide a transparent outer tube for a vehicular exhaust pipe, which increases the value of the vehicle.

It is another object of the present invention to provide a transparent outer tube for a vehicular exhaust pipe, which is safe.

### BRIEF DESCRIPTION OF THE DRAWINGS

FIG. 1 is an exploded view of a first embodiment of the present invention;

FIG. 2 is a perspective view of FIG. 1;

FIG. 3 is a perspective view of a second embodiment of the present invention;

FIG. 4 is a perspective view of a third embodiment of the present invention;

FIG. 5 is an exploded view of a fourth embodiment of the present invention; and

FIG. 6 is a perspective view of the fourth embodiment of the present invention;

### DETAILED DESCRIPTION OF THE PREFERRED EMBODIMENT

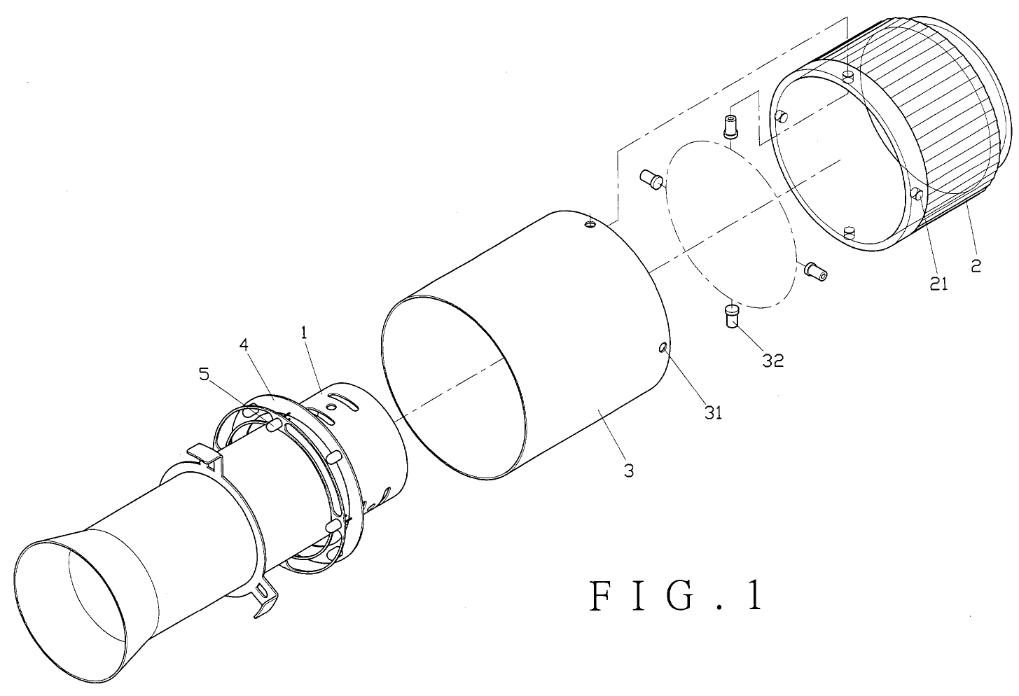

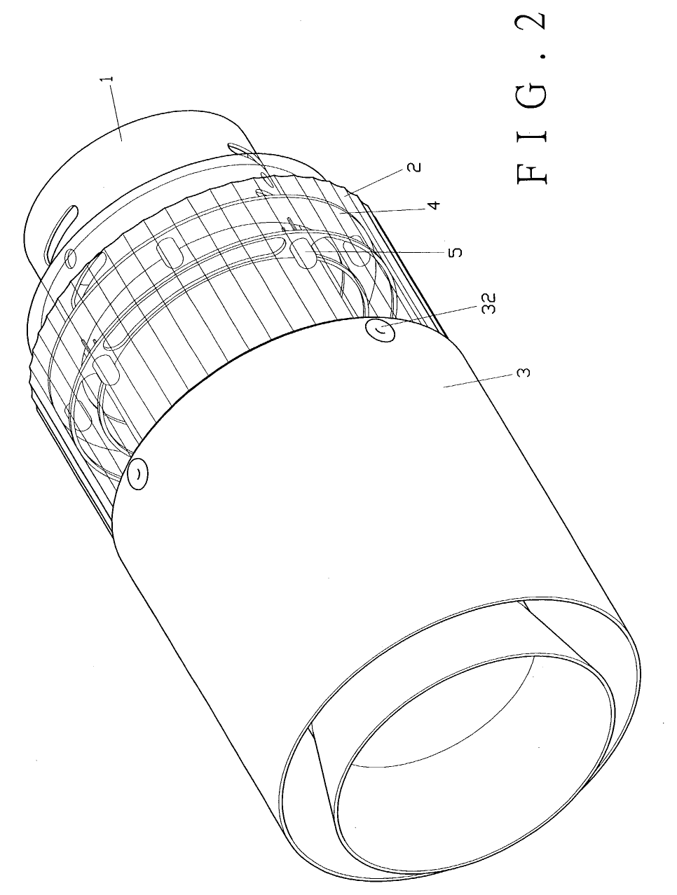

The transparent outer tube for a vehicular exhaust pipe of the present invention, as shown in FIGS. 1 and 2, comprises an inner tube 1, a first outer tube 2, a second outer tube 3, a socket 4 and a plurality of illumination devices 5. The inner tube 1 is secured within the first outer tube 2 to form a space between the inner tube 1 and the first outer tuber 2. The space receives the socket 4 and the illumination devices 5 secured therein. The first outer tube 2 comprises through holes 21 at the end, and the second outer tube 3 also comprises through holes 31 at the front corresponding to the through holes 21of the first outer tube 2 for connection of the second outer tube 3 with the first outer tube 2 by means of rivets 32. The first outer tube 2 is made of heat-resistant and transparent material. In the embodiment, a circumferential portion of the first outer tube 2 is axially formed with corrugated waves, and the second outer tube 3 is made of metal material (such as stainless steel). Thus the illumination devices 5 produce light emitting direct or indirect to the tail of the exhaust pipe and reflecting through the first outer tube 2 thereof.

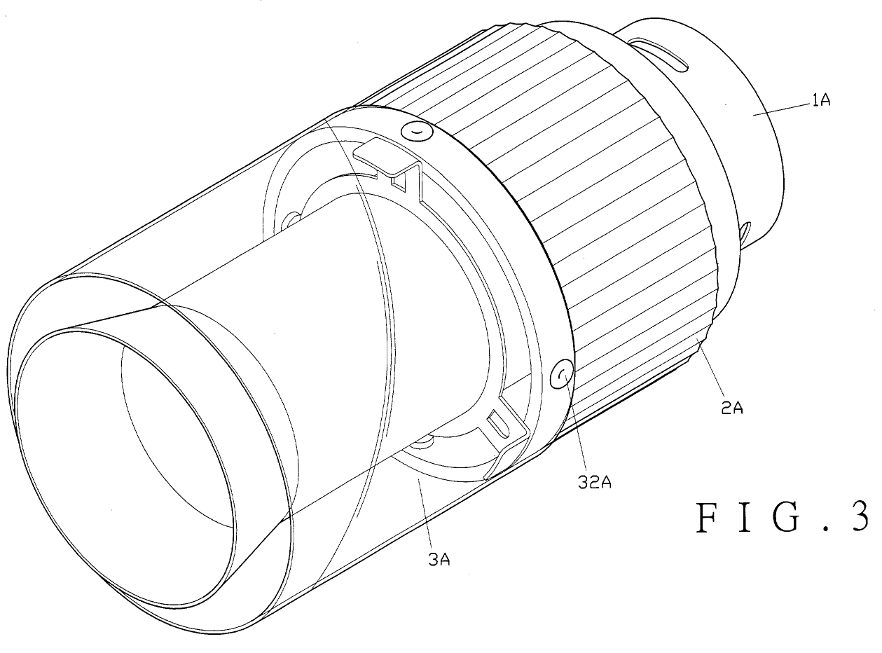

A second embodiment of the present invention, as shown in FIG. 3, comprises an inner tube 1A, a first outer tube 2A, a second outer tube 3A (a socket and illumination devices are set within the first outer tube 2A, not shown in the drawing). The inner tube 1A is spaced securely to the first outer tube 2A, forming a space thereat, which is to receive the socket and the illumination devices. The first outer tube 2A is axially connected with the second outer tube 3A by means of rivets 32A. The second outer tube 3A is made of heat-resistant and transparent material, and the first outer tube 2A is made of metal material (such as aluminum). A circumferential portion of the first outer tube 2A is axially formed with corrugated waves. Thus the illumination devices 5 produce light emitting direct or indirect to the tail of the exhaust pipe and reflecting through the second outer tube 3A thereof.

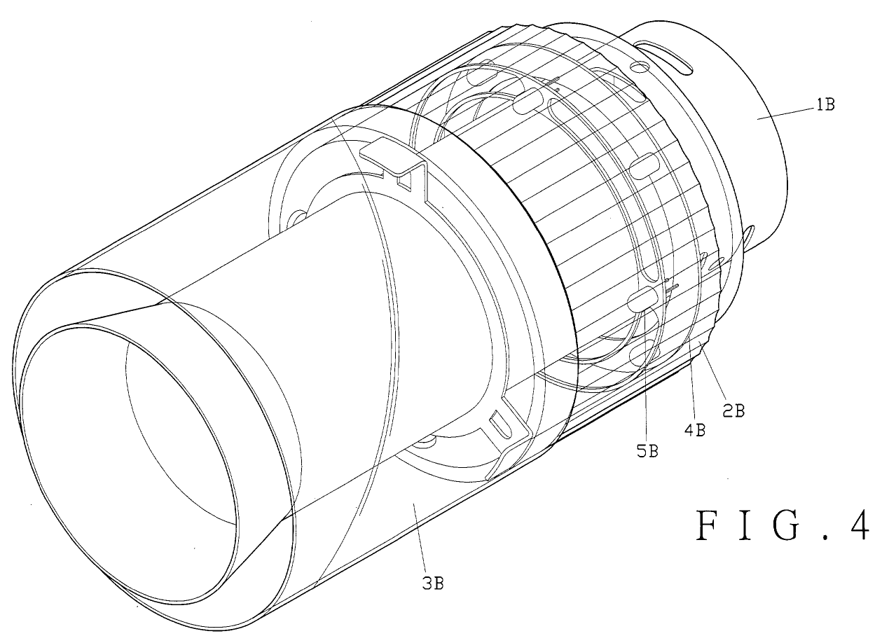

A third embodiment of the present invention, as shown in FIG. 4 comprises an inner tube 1B, a first section outer tube 2B, a second section outer tube 3B, a socket 4B and illumination devices 5B. The inner tube 1B is spaced securely to the first section outer tube 2B, forming a space thereat, which is to receive the socket 4B and the illumination devices 5B therein. The first section outer tube 2B and the second section outer tube 3B are both made of heat-resistant and transparent material, and they are formed integrally. A circumferential portion of the first section outer tube 2B is axially formed with corrugated waves. Thus the illumination devices 5B produce light emitting direct or indirect to the tail of the exhaust pipe and reflecting through the first section outer tube 2B and the second section outer tube 3B thereof.

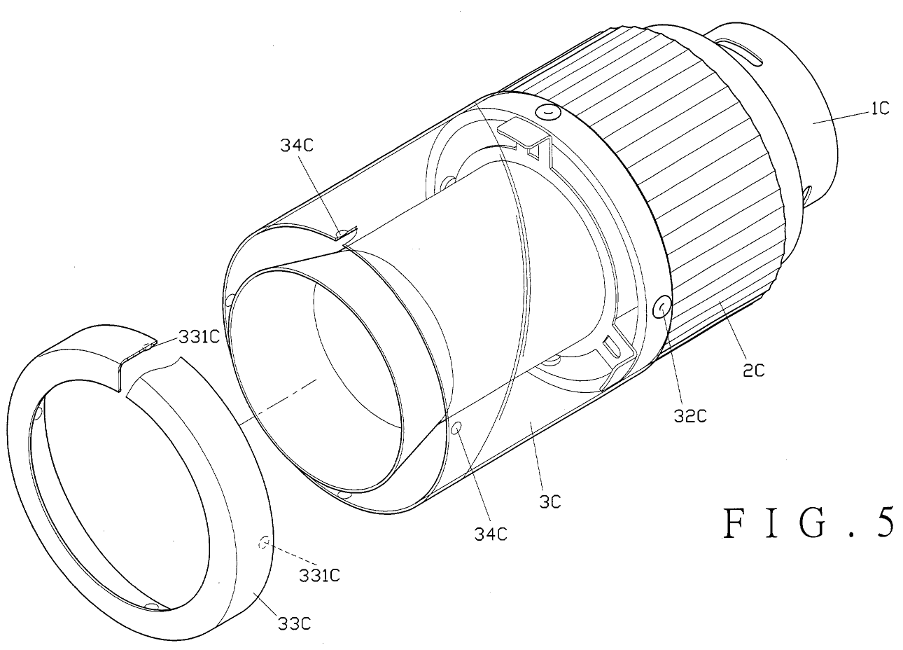

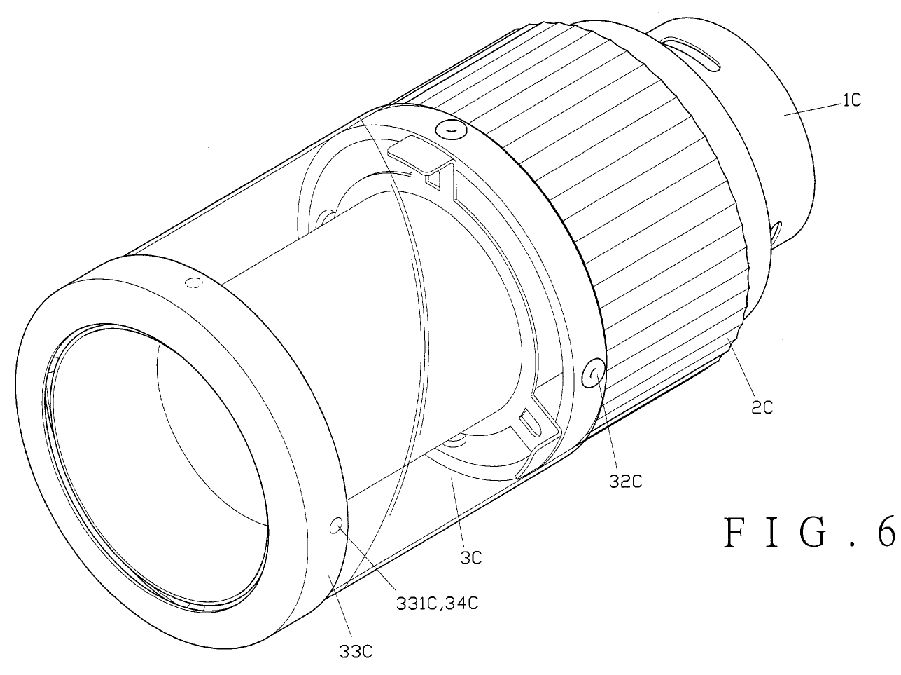

A fourth embodiment of the present invention, as shown in FIGS. 5 and 6, comprises an inner tube 1C, a first outer tube 2C, a second outer tube 3C, (a socket and illumination devices are set within the first outer tube 2C, not shown in the drawings). The first outer tube 2C is axially secured with the second outer tube 3C by means of rivets 32C. The second outer tube 3C comprises a ring 33C at the end. A plurality of recesses 34C are formed at the end of the second outer tube 3C and a plurality of protuberances 331C are formed on the ring 33C corresponding to the recesses 34C for connection purpose. The second outer tube 3C is made of heat-resistant and transparent material while the first outer tube 2C and the ring 33C are made of metal material. In this embodiment, the material of the first outer tube 2C is aluminum, and the material of the ring 33C is stainless steel. A circumferential portion of the first section outer tube 2C is axially formed with corrugated waves. Thus the illumination devices produce light emitting direct or indirect to the ring 33C or refracting through the second outer tube 3C.

I claim:

1. A transparent outer tube for a vehicular exhaust pipe comprising an inner tube, a first outer tube, a second outer tube, a socket and a plurality of illumination devices, wherein said inner tube being secured with said first outer tube in a distance and forming a space therein adapted to receive said socket and said illumination devices therein, said first outer tube being axially secured with said second outer tube, either said first outer tube or said second outer tube or both of said outer tubes being made of heat-resistant and transparent material, thus light from said illumination devices being emitted direct or indirect to a tail of said exhaust pipe and inflecting through said first outer tube or said second outer tube.

2. The transparent outer tube for a vehicular exhaust pipe, as recited in claim 1, wherein said second outer tube of said exhaust pipe comprises a ring at one end.

3. The transparent outer tube for a vehicular exhaust pipe, as recited in claim 2, wherein said second outer tube comprises a plurality of recesses at one end portion, and wherein said ring comprises a plurality of protuberances corresponding to said recesses.
